(19) United States
(12) Patent Application Publication
(10) Pub. No.: US 2026/0203670 A1
(43) Pub. Date: Jul. 16, 2026

(54) Selective Evaluation of Generative Models

(71) Applicant: ServiceNow, Inc., Santa Clara, CA (US)

(72) Inventors: Srinivas Aluvala, Hyderabad (IN); Yashmita Balotiya, Hyderabad (IN); Vipin Kumar, New Delhi (IN); Chirag Ahuja, Bangalore (IN)

(21) Appl. No.: 19/017,104

(22) Filed: Jan. 10, 2025

(51) Int. Cl. G06N 20/20

(52) U.S. Cl. CPC G06N 20/20

(57) ABSTRACT

A method is provided for more efficient use of a set of tests to evaluate a machine learning (ML) model. The method includes using one or more parameters that characterize each of the tests, in combination with an estimated competence score for the ML model, to determine performance measures for each of the tests with respect to their ability to assess the ML model and thereby facilitate improvement of the estimated competence score thereof. The performance measures are used to select one of the tests, which is applied to the ML model to assess it. The ML models' performance on the selected test (e.g., success or failure) is used to update the estimated competence score, which is in turn used to update the performance measures for the non-selected tests. A second test is selected, and the process iteratively repeated to improve the estimated competence score for the model under test.

### BACKGROUND

A variety of tests are available to assess the capability of trained machine learning models with respect to various tasks. However, as the machine learning models advance, resulting in increased or otherwise changed competencies, the available tests may become less able to accurately or usefully assess such new models, or to distinguish between them. Accordingly, new tests may be created over time to account for advances in the capabilities of the models to be tested. However, the generation and evaluation of such tests can involve significant computational costs (e.g., storage space to maintain the information defining the tests, processor cycles, power, memory, bandwidth, and/or other computational resources to evaluate the tests). Indeed, the act of evaluating a test with respect to a particular machine learning model can, itself, implicate significant computational costs (e.g., when the output of a model being tested is applied to another machine learning model in order to evaluate the correctness or quality of the output).

### SUMMARY

It can be beneficial to develop sets of tests to evaluate trained machine learning models, thereby determining the models' absolute or relative competences with respect to a variety of tasks. Such evaluations can allow low-competence models to be discarded (thus saving storage space or other computational resources related to maintenance of such models), high-competence models to be selected for target tasks (thus resulting in higher-quality outputs), or other benefits to be obtained. In some examples, results of the models' performance on the tasks can be used to train, update, or refine the models, thereby improving them, and/or to identify types or classes of models that exhibit high competence with respect to one or more tasks and that, thus, should be further developed.

In practice, a set of tests can span a range with respect to the difficultly that each test poses to a machine learning model being evaluated. Thus, it may be wasteful to apply tests that are too easy or too hard to a given model, since the model's overall level of competence may be more thoroughly evaluated using middling difficulty tests. However, since machine learning models may exhibit varying levels of competence with respect to a range of different tasks, the difficulty of particular tests may also differ from model to model, meaning that a set of tests cannot be simply ordered from easy to difficult. Accordingly, a naïve method of evaluating a machine learning model may involve simply applying all of the available tests thereto. The set of results of such extensive evaluation can then be used to compare the relative competence of different models or to perform some other model-related application. Such a method, however, makes it more difficult to directly compare two or more models than if they were represented by a single competence value based on an overall competence with respect to a set of tests. Furthermore, and as noted above, the application of such tests may consume significant amounts of computational resources (e.g., processor cycles, power, memory, bandwidth).

The methods described herein overcome these shortcomings. These methods include characterizing each test in a set of tests by one or more parameters, e.g., by a difficulty parameter that represents a level of difficulty of the test and a discrimination parameter that represents the ability of the test to discriminate between models of similar competence. Each model under test can be characterized by a competence score (which may be a scalar to represent overall competence, or which may be multivariate to represent competence with respect to a number of different abilities of the model). Doing so can lead to more efficient selection of further tests to more fully characterize the capabilities of the model(s).

Accordingly, what is disclosed herein can save the processor cycles, power, or other computational costs of evaluating the utility of such tests relative to new, to-be-evaluated models as well as the potentially significant costs with respect to storage and bandwidth related to maintaining and accessing copies of such tests. Alternatively, tests that are, at present, too difficult to be useful in evaluating a present set of models could be archived and, once more advanced models are obtained, retrieved and put into use again.

Accordingly, a first example embodiment may involve a method that includes: (i) obtaining a machine learning (ML) model and a competence score of the ML model; (ii) obtaining a set of tests for evaluating ML models, wherein each test of the set of tests comprises one or more respective parameters, wherein the one or more respective parameters for a given test of the set of tests indicate performance of the given test in evaluating ML models; (iii) determining, based on the competence score and the one or more respective parameters for each of the tests, corresponding performance measures for each of the tests with respect to the ML model; (iv) based on the corresponding performance measures, selecting a first test of the set of tests; (v) applying the first test to evaluate the ML model; (vi) based on applying the first test, updating the competence score of the ML model; (vii) determining, based on the updated competence score and the one or more respective parameters for each of the tests, corresponding updated performance measures for each of the tests with respect to the ML model; (viii) selecting, based on the corresponding updated performance measures, a second test of the set of tests; (ix) applying the second test to evaluate the ML model; and (x) based on applying the second test, further updating the competence score of the ML model.

A second example embodiment may involve a non-transitory computer-readable medium, having stored thereon program instructions that, upon execution by a computing system, cause the computing system to perform operations in accordance with any of the previous example embodiments.

In a third example embodiment, a computing system may include at least one processor, as well as memory and program instructions. The program instructions may be stored in the memory, and upon execution by the at least one processor, cause the computing system to perform operations in accordance with any of the previous example embodiments.

In a fourth example embodiment, a system may include various means for carrying out each of the operations of any of the previous example embodiments.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6A depicts a process of using a set of tests to evaluate a model, in accordance with example embodiments.

FIG. 6B depicts a process of using a set of tests to evaluate a model, in accordance with example embodiments.

FIG. 6C depicts a process of using a set of tests to evaluate a model, in accordance with example embodiments.

FIG. 7 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of software features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. EXAMPLE TECHNICAL IMPROVEMENTS

These embodiments provide a technical solution to a technical problem. One technical problem being solved is maintaining and applying sets of tests in order to evaluate machine learning models. Such assessments allow low-quality models to be deleted, thereby avoiding the storage, bandwidth, and other computational costs of maintaining the low-quality models. Such assessments can also allow available computational resources (e.g. processor cycles, memory, power) to be allocated for use with higher-quality models, avoiding wasting such resources on the execution of low-quality models. In practice, such assessment is problematic because the tests themselves may implicate significant storage and bandwidth costs associated with storing and retrieving representations of the tests between evaluations. Additionally the use of a test, or set of tests, to evaluate a machine learning model can require the use of significant computational resources (e.g., processor cycles, power, memory, bandwidth), to execute the model under test itself and potentially to perform other processes related to evaluation of the test (e.g., execution of a secondary machine learning model to evaluate the output of the model under test).

In other techniques, each test in a set of tests could be evaluated in turn, and/or evaluated in “difficulty order” in order to evaluate the performance level of a model, with the performance level determined based on the outcome of all of the evaluated tests. However, these techniques involve the computational costs of retrieving and evaluating large numbers of tests (e.g., all of the available tests). The embodiments herein overcome these limitations by using an estimate of the performance of the model under test, and parameterized estimates of the efficacy (e.g., difficulty, discrimination) of each of the tests, to select which of the test(s) to evaluate in order to efficiently update the performance estimate for the model.

Such a method allows the utility, with respect to refining the current performance estimate for the model, of each test in a set of tests to be efficiently computed (e.g., as a Fisher Information). These test performance measures are then used to select one of the tests (e.g., the test with the highest performance measure) to evaluate the model. The model's performance with respect to the selected test (e.g., success or failure) can then be used, with the selected test's parameter(s), to update the competence score for the model. The updated model competence score can then be used to update the performance measures for the other tests, and the process repeated, iteratively selecting tests and improving the model competence score estimate. The iterative process can then be terminated when one or more termination criteria are satisfied, e.g., the competence score estimate stabilizes, a predicted error of the confidence score falls below a threshold value, a maximum number of test evaluations is reached, etc., Such a process can allow a model to be accurately evaluated without using every test in a set of tests, thereby reducing the computational cost of evaluating the model.

Such methods can also provide benefits with respect to curating a set of tests. For example, as models are added (or removed) from a set of models to be evaluated, the parameter(s) for the tests can be updated. As more advanced models are developed, and thus the overall competence scores of the set of models increase, the effective ‘difficulty’ and/or ‘discrimination’ of the available tests may decrease. Particularly low-utility tests (e.g., tests whose ‘difficulty’ is too low to ever be useful in evaluating newer, more advanced models) can be identified based on their lowered parameter(s) and responsively removed from the set of tests. Accordingly, what is disclosed herein can save the processor cycles, power, or other computational costs of evaluating the utility of such tests relative to new, to-be-evaluated models as well as the potentially significant costs with respect to storage and bandwidth related to maintaining and accessing copies of such tests. Alternatively, tests that are, at present, too difficult to be useful in evaluating a present set of models could be archived and, once more advanced models are obtained, retrieved and put into use again.

Other technical improvements may also flow from these embodiments, and other technical problems may be solved. Thus, this statement of technical improvements is not limiting and instead constitutes examples of advantages that can be realized from the embodiments.

### II. INTRODUCTION

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or extensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### III. EXAMPLE COMPUTING DEVICES AND CLOUD-BASED COMPUTING ENVIRONMENTS

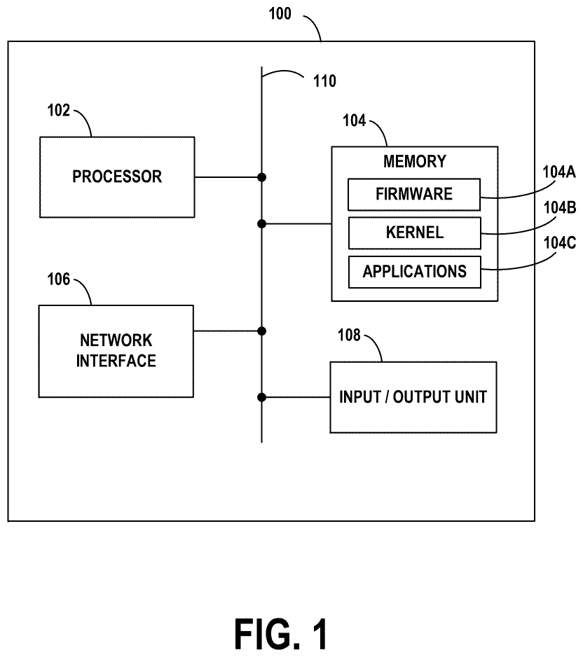

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), a digital signal processor (DSP), a network processor, an encryption processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently used instructions and data.

GPUs, in particular, have grown in importance. They include specialized circuitry designed to perform rapid mathematical calculations for rendering graphics, processing large datasets, and supporting machine learning. A GPU typically consists of hundreds or thousands of small cores that operate simultaneously, facilitating the decomposition of tasks into smaller, more manageable pieces that are processed in parallel. This parallelism allows GPUs to be significantly faster than traditional CPUs for certain types of calculations.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Herein, any non-volatile memory may be referred to as persistent storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Synchronous Digital Hierarchy (SDH), Data Over Cable Service Interface Specification (DOCSIS), or other technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

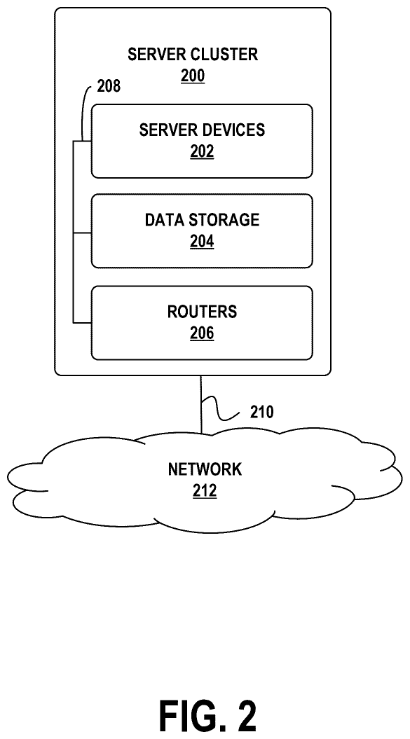

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. EXAMPLE REMOTE NETWORK MANAGEMENT ARCHITECTURE

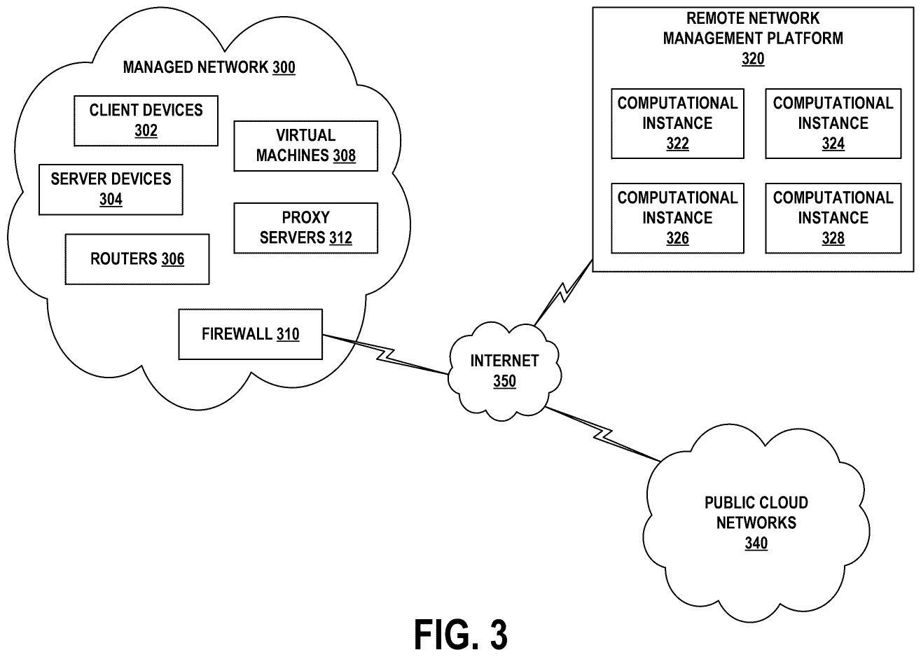

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

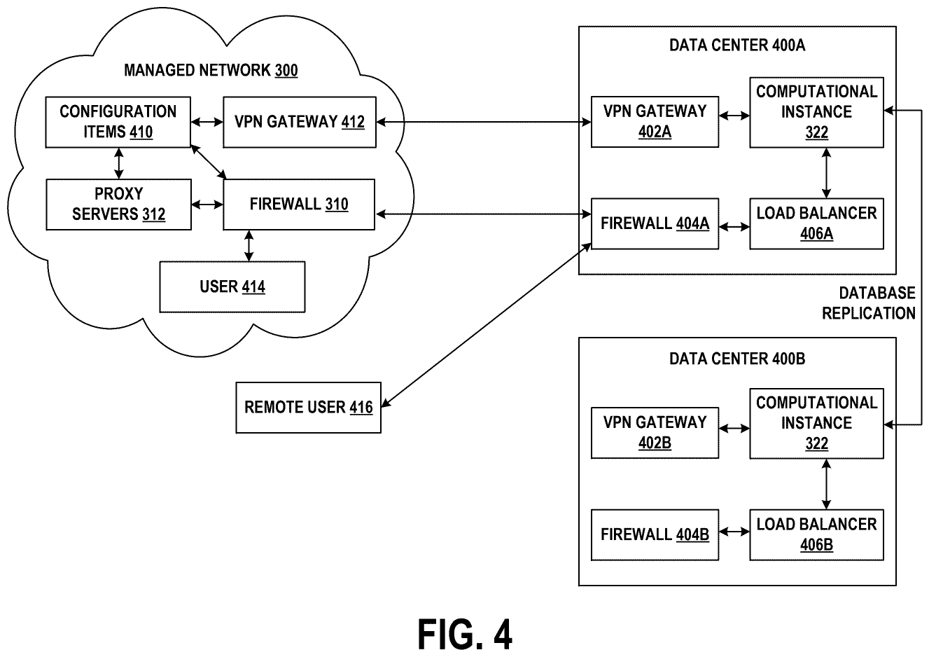

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300.

As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V. EXAMPLE DISCOVERY

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

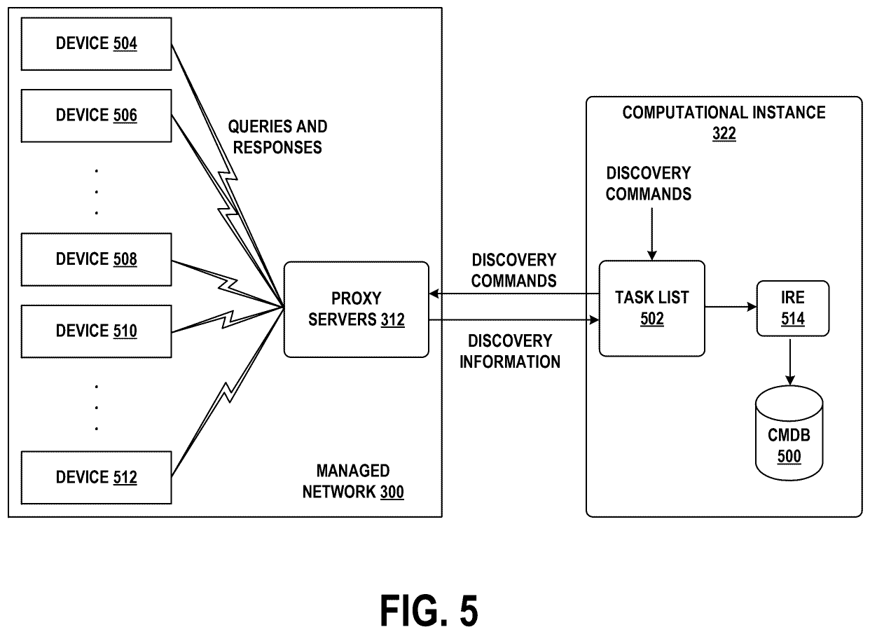

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery-horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases-under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI. CMDB IDENTIFICATION RULES AND RECONCILIATION

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII. EXAMPLE MACHINE LEARNING MODELS

A machine learning model as described herein includes any model that is trained using a set of training data to generate an output (e.g., a classifier label, text, images, a predicted value) from an input (e.g., text, an image, a vector or otherwise-organized set of values). For example, a machine learning model could be trained using a corpus of text (e.g., the publicly visible textual contents of the internet) to answer questions, satisfy instructions, and/or operate on some other textual input by generating a corresponding textual output. In another example, a machine learning model could be trained to predict whether an input microcopy image of a tissue sample contains cancer cells or otherwise represents a disease state (e.g., by outputting a label indicative of “disease” or “not disease,” by outputting a continuous-valued scalar output the represents a likelihood that the sample is diseased, by outputting multiple continuous-valued scalar outputs that respectively represent likelihoods that the sample is diseased or not diseased).

A machine learning model can be trained in a variety of ways based on a variety of training inputs. The training can be supervised (i.e., paired sets of inputs and ‘true’ outputs therefor, which the training attempts to cause the model to accurately recapitulate), unsupervised (e.g., the training attempts to cause the model to output labels or other representations of inputs that accurately represent some underlying structure in the inputs, without access to known ‘true’ examples of that structure), and/or some combination (e.g., semi-supervised). The architecture of a machine learning model can take a variety of forms, and can include without limitation one or more artificial neurons or artificial neural networks, convolutional networks, filters (e.g., filter kernels of a convolutional neural network), fully or partially connected layers of computational nodes (e.g., artificial neurons), mapping functions, projection functions, encoders, decoders, quantizers, nonlinear output functions, attention functions, or other elements or combinations of elements to generate an output.

In some examples, the machine learning model could be or include a large language model (LLM), which is a variety of very large, multi-layered model (e.g., based on one or more transformers) that is able to operate on input text (e.g., token strings that represent arbitrary input text) and to generate therefrom output text (e.g., token strings that can be translated into text) that answers a question within the input, that performs a task within the input, that satisfies a format or other constraint in the input, or that otherwise corresponds to, answers, and/or satisfies some aspect to the input. An LLM is an advanced computational model, primarily functioning within the domain of natural language processing (NLP) and machine learning. An LLM can be configured to understand, interpret, generate, and respond to human language in a manner that is both contextually relevant and syntactically coherent. The underlying structure of an LLM is typically based on a neural network architecture, more specifically, a variant of the transformer model. Transformers are notable for their ability to process sequential data, such as text, with high efficiency.

The operation of an LLM involves layers of interconnected processing units, known as neurons, which collectively form a deep neural network. This network can be trained on vast datasets comprising text from diverse sources, thereby enabling the LLM to learn a wide array of language patterns, structures, and colloquial nuances for prose, poetry, and program code. The training process involves adjusting the weights of the connections between neurons using algorithms such as backpropagation, in conjunction with optimization techniques like stochastic gradient descent, to minimize the difference between the LLM's output and expected output.

An aspect of an LLM's functionality is its use of attention mechanisms, particularly self-attention, within the transformer architecture. These mechanisms allow the model to weigh the importance of different parts of the input text differently, enabling it to focus on relevant aspects of the data when generating responses or analyzing language. The self-attention mechanism facilitates the model's ability to generate contextually relevant and coherent text by understanding the relationships and dependencies between words or tokens in a sentence (or longer parts of texts), regardless of their position.

Upon receiving an input, such as a text query or a prompt, the LLM may process this input through its multiple layers, generating a probabilistic model of the language therein. It predicts the likelihood of each word or token that might follow the given input, based on the patterns it has learned during its training. The model then generates an output, which could be a continuation of the input text, an answer to a query, or other relevant textual content, by selecting words or tokens that have the highest probability of being contextually appropriate.

Furthermore, an LLM can be fine-tuned after its initial training for specific applications or tasks. This fine-tuning process involves additional training (e.g., with reinforcement from humans), usually on a smaller, task-specific dataset, which allows the model to adapt its responses to suit particular use cases more accurately. This adaptability makes LLMs highly versatile and applicable in various domains, including but not limited to, chatbot development, content creation, language translation, and sentiment analysis.

Some LLMs are multimodal in that they can receive prompts in formats other than text and can produce outputs in formats other than text. Thus, while LLMs are predominantly designed for understanding and generating textual data, multimodal LLMs extend this functionality to include multiple data modalities, such as visual and auditory inputs, in addition to text.

A multimodal LLM can employ an advanced neural network architecture, often a variant of the transformer model that is specifically adapted to process and fuse data from different sources. This architecture integrates specialized mechanisms, such as convolutional neural networks for visual data and recurrent neural networks for audio processing, allowing the model to effectively process each modality before synthesizing a unified output.

The training of a multimodal LLM involves multimodal datasets, enabling the model to learn not only language patterns but also the correlations and interactions between different types of data. This cross-modal training results in multimodal LLMs being adept at tasks that require an understanding of complex relationships across multiple data forms, a capability that text-only LLMs do not possess. This makes multimodal LLMs particularly suited for advanced applications that necessitate a holistic understanding of multimodal information, such as chatbots that can interpret and produce images and/or audio from

### VIII. EXAMPLE MODEL TESTING AND TEST SET CURATION METHODS

It is desirable in a variety of circumstances to evaluate the accuracy, efficacy, or other aspects of machine learning models. Such testing can be done to determine whether an off-the-shelf model is suitable for a particular (e.g., novel) task, to select amongst a set of models to perform a task and/or to fine-tune on a task, to curate a set of available models (e.g., to deprecate low-quality models, to select models to fork and/or subject to additional training), or to make some other decision or perform some other action with respect to one or more models based on their performance on one or more tests. Tests can also allow different models to be compared against each other in order to, e.g., select between different models to perform a particular target task. Tests can allow such comparisons to be performed offline, as a result of separate testing of two (or more) models, rather than head-to-head, allowing new (or re-trained) models to be compared to existing models and/or to perform comparisons between models according to one or more constraints. For example, to identify a subset of available models that satisfy a constraint with respect to available or acceptable memory use, processor cycle or power use, latency, or some other technical constraint and then to select within the subset the ‘best’ model.

However, it can be difficult and computationally expensive to develop and apply such tests. For example, application of a test can include both the computational cost (e.g., processor cycles, power, memory) of performing at least one inference using the model under test and the computational cost of inferencing another model in order to, e.g., assess the quality of the output of the model under test. Additionally, it can be expensive with respect to storage space and bandwidth to store and retrieve tests, as the tests can include significant amounts of data to specify input examples, assessment code, output examples (which may include examples of low, high, and other levels of quality in order to quantify the quality of the output generated by a model under test), or other large data objects.

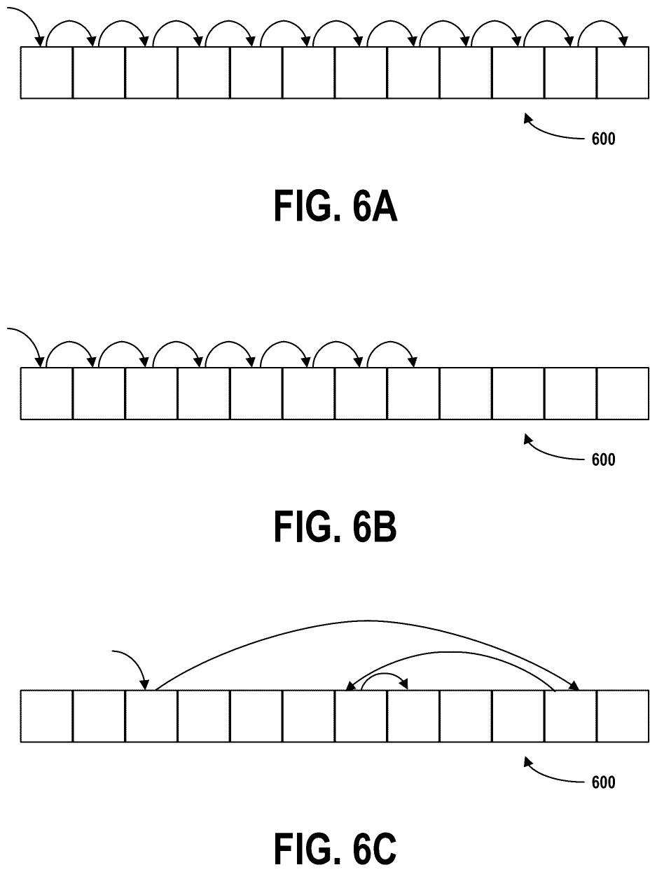

The process of testing can be further complicated by the fact that, generally, different models have different levels of competence with respect to different tasks, or even different aspects of a single task (e.g., general knowledge, task-specific knowledge, accuracy, ability to interpret and satisfy formatting or other auxiliary constraints). Thus, it can be difficult to fully assess a model for comparison with other models using a single test. Additionally, as the set of available models expands to include more competent, newer models, the efficacy of the existing tests to adequately assess and discriminate between the models may decrease (e.g., as the set of models comes to outpace the difficulty of the available tests).

Where a set of tests is available to assess a model, a naïve strategy is to apply all of the tests to the model, and use the outputs of the tests (e.g., all of the outputs, or a summary statistic representing an aggregate “competence score” for the model) to assess the model and/or compare the model to other models. FIG. 6A illustrates such a strategy, which includes obtaining a set of tests 600 and then applying each of them in order (indicated by the curved arrows) to a model under test. However, such a strategy is extremely computationally expensive, resulting in the use of an amount of processor cycles, power, processor time, or other computational resources for every one of the tests in the set of tests 600.

Instead, the set of tests could be ordered with respect to ‘difficulty’ and the tests applied to a model from one level of difficulty to the other (e.g., more easiest to most difficult) until a termination criterion is reached (e.g., until the model fails, or succeeds, at a test, depending on whether the tests are applied easy-to-difficult or difficult-to-easy, respectively). FIG. 6B illustrates such a strategy, which includes obtaining the set of tests 600 and then applying each of them in order (indicated by the curved arrows) to a model under test, from easy to difficult, until the model fails or satisfies some other termination criterion (e.g., fails at least two or three tests in a row). Such a strategy is more efficient than the naïve strategy of FIG. 6A, in that it is able to be completed with a computational cost that is less than that of performing all of the tests (e.g., with the cost of performing eight tests in FIG. 6B, rather than twelve as in FIG. 6A).

However, since there is no single ‘difficulty’ according to which a set of tests can be arranged with respect to all possible models, it is difficult to determine exactly how to order a given set of tests to accomplish such a strategy. One solution would be to perform all of the tests for a set of models in order to determine therefrom such a difficulty ordering across a population of models; however, such a method implicates significant computational costs itself. Additionally, it can be difficult to distill the results of such a strategy for a single model into a single (or multiple) estimates of model competence, since it is possible for a model to succeed on a test that is ‘more difficult’ than a preceding, ‘less difficult’ test for which it failed.

The methods described herein overcome these shortcomings to efficiently select and apply a sequence of tests (of a set of tests) to a model in order to efficiently refine a single estimated competence score for the model. The application of these methods allows a high-quality model competence score to be determined while applying fewer tests (and thus implicating a correspondingly reduced cost with respect to processor cycles, memory user, power use, or other computational costs). This is accomplished by determining a set of one or more parameters for each of the tests, such that the parameter(s) quantify the ability of the test to assess machine learning models. For example, a parameter that represents the overall ‘difficulty’ of the test, and another ‘discrimination’ parameter that represents the ability of the test to distinguish between two models that are similar in competence, but near the level of competence that equals the ‘difficulty’ of the test. These parameters are used, in combination with a current estimate of the competence score for the model, to determine a performance measure for each of the tests. The performance measures represent the expected relative value of using each of the tests with respect to improving the estimate of the competence score for the model (e.g., a Fisher information of the test), and so can be used to select the ‘best’ test to apply to the model. Once applied, the results of the test (e.g., success vs. failure) are used to update the competence score for the model.

By selecting and applying the ‘best’ tests in this way, the overall number of tests applied in order to develop an accurate estimate of the competence of a model can be reduced, thereby reducing the overall computational cost to assess the model. Such a strategy is more efficient than the strategies of FIGS. 6A and 6B, in that it is able to be completed with a computational cost that is less than that of performing all of the tests from ‘least difficult’ to ‘as difficult as the model can accomplish’ (e.g., with the cost of performing four tests in FIG. 6C, rather than eight as in FIG. 6B or twelve as in FIG. 6A). This benefit is obtained by using the test parameters and current model competence score to determine, at each iteration, which of the tests will most refine the estimate (e.g., provide the most information about the competence score), thereby allowing the computational cost less-informative tests to be avoided. This includes selecting an intermediate-difficulty test (e.g., the third test from the left) as the first test applied in FIG. 6C, avoiding the computational costs of applying less-difficult tests, which would be less informative, first.

Such a process also has the benefit of not requiring the tests to be arranged (or even to have the property of being able to be arranged) in a sequence with ‘difficulty’ monotonically increasing. Such a process also allows the competence of a model (and the corresponding parameters of the tests) to be multi-valued (e.g., vector-valued) to represent various different tasks or sub-tasks, and further allows such multiple competence values to be efficiently assessed using a reduced number of the available tests. This could be accomplished by, e.g., adapting the methods described herein to determine the performance measures for the tests as a sum or overall amount of information about the set of competences that is likely to be generated by the application of each of the tests.

The tests could be parameterized, and the performance measures determined therefrom (in combination with the estimated model competence score(s)) in a variety of ways. For example, the tests could be parameterized to include a discrimination parameter that represents the ability of the tests to discriminate between tests of similar competence. In such examples, the performance measure for the tests could be determined based on the estimated probability of success of the model with respect to each of the tests (as determined based on the current estimate of the competence score and the test parameters). For example, the performance measure could be the Fisher information for each of the tests:

$$I ( θ ) = {a}^{2} P ( θ ) ( 1 - P ( θ ) )$$

where a is the discrimination parameter for the test, θ is the current estimated model competence, and P(θ) is the estimated probability of success of a model of competence θ with respect to the test.

Such an estimated probability of success could be determined in a variety of ways. For example, the probability of success could be determined as:

$$P ( θ ) = 1 / {e}^{- a ( θ - b )}$$

where b is a difficulty parameter that represents a level of difficulty of the tests, with tests that are more competent than a corresponding competence score being more likely to succeed at the test, and tests that are less competent than the corresponding competence score being less likely to succeed at the test.

Such a probability of success (determined as in the above equation, or in some other manner) could also be used to update the estimated competence score based on the performance of the model on the selected test. For example, a maximum likelihood estimator or a Bayesian estimator could be used to update the competence score based on the estimated probability of success and whether the model succeeded (or failed) at the selected test.

The updated competence score could then be used, in combination with the parameters for the remaining tests, to update the performance measures for the remaining tests and, based on the updated performance measures, select a next test to apply to the model. Such an iterative process could be repeated, updating the estimated model competence score each time until one or more termination criteria are met. Such termination criteria could include reaching a maximum number of applied tests (e.g., all of the available tests, or a number of tests less than the total number of tests). Such termination criteria could include the estimated confidence score “plateauing,” i.e., changing by less than a specified absolute or relative amount over a specified number (e.g., two, three) of consecutive applied tests (e.g. changing by less than 0.1 between one applied test and the next). Such termination criteria could include determining that a standard error of measurement (SEM) or some other estimate of the error or inaccuracy of the competence score is less than a specific level. For example, determining that SEM(θ)=1/\sqrt{I(θ)} is less than 0.3 or some other threshold level. Such termination criteria could include the model plateauing with respect to performance on a set number of applied tests, e.g., failing or succeeding at more than a specified number (e.g., three) tasks in a row.

As noted above, these methods improve the efficiency with which a set of tests can be used to evaluate a model, e.g., by using the methods described herein to iteratively select the ‘best’ test to evaluate a model and update an estimated competence score thereof, thereby arriving at a highly accurate competence score estimate while applying fewer overall tests. This methods also provide benefits with respect to the maintenance and curation of such a set of tests. This is because the set of parameters for each test (e.g., the discrimination and difficulty parameters for each test) can be used to compare the tests relative to each other and relative to a set of models of interest. Once the set of tests have been used to evaluate a number of different models, the sets of parameters for the tests can be updated based on their ability to evaluate the models. Such updates can occur repeatedly, as new models are added to (and, optionally, old, low-quality models removed from) the set of models.

As the set of models becomes, overall, more competent, certain tests of the set of tests could become non-useful. For example, the overall difficult of a test could become irrelevant as every model in the set of models comes to easily succeed at the test. In such cases, the storage and other computational costs (e.g., bandwidth, database operations) associated with retaining such a low-utility test could be avoided by deleting the test. This could be accomplished by, e.g., updating the parameters for every test in at set of tests and then deleting any tests whose overall difficulty parameter(s) are less than an absolute value, or that are less than a relative value (e.g., less than a set percentile level relative to the population of difficulty parameters across the set of tests).

Alternatively, a test that is particularly difficult with respect to a set of models could be archived for later use. Once the overall and/or range of competences of the set of models increases (e.g., due to more competent newer models being added), such high-difficulty test(s) can be retrieved from archive storage and added to the available set of tests. This could be done in response to determining, e.g., that the difficulty parameter(s) of one or more tests present in the set of tests when the high-difficulty test was archived have been reduced by more than a set absolute or relative threshold amount. Such operations also conserve the computational and other resources involved in generating such tests, by allowing them to be used once the available models advance to the point that they are relevant.

### IX. EXAMPLE OPERATIONS

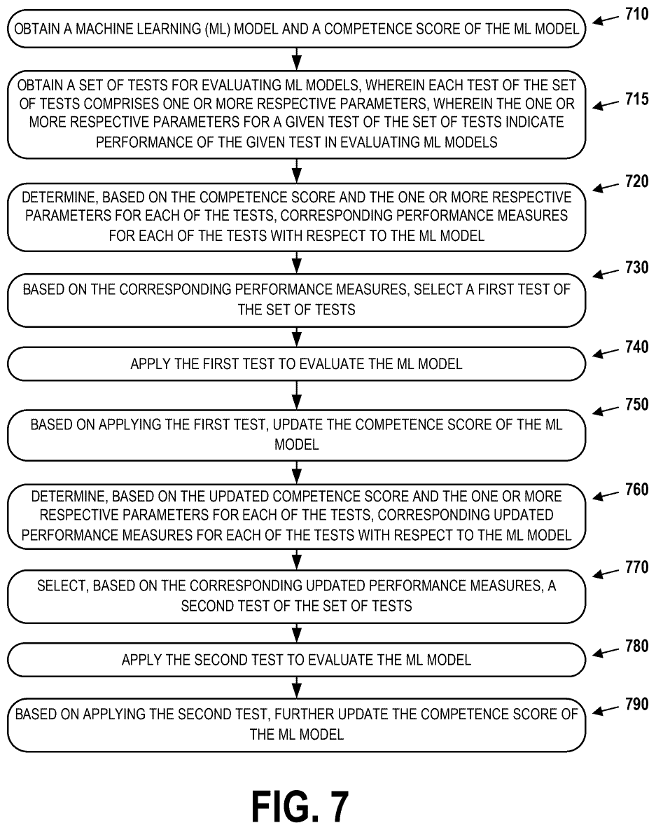

FIG. 7 is a flow chart illustrating an example embodiment. The process illustrated by FIG. 7 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 7 may be simplified by the removal of any one or more of the features shown therein. Further, these embodiments may be combined with features, aspects, and/or implementations of any of the previous figures or otherwise described herein.

The embodiments of FIG. 7 include, at block 710, obtaining a machine learning (ML) model and a competence score of the ML model. The embodiments of FIG. 7 include, at block 715, obtaining a set of tests for evaluating ML models, wherein each test of the set of tests comprises one or more respective parameters, wherein the one or more respective parameters for a given test of the set of tests indicate performance of the given test in evaluating ML models.

The embodiments of FIG. 7 include, at block 720, determining, based on the competence score and the one or more respective parameters for each of the tests, corresponding performance measures for each of the tests with respect to the ML model. The embodiments of FIG. 7 include, at block 730, selecting a first test of the set of tests based on the corresponding performance measures and, at block 740, applying the first test to evaluate the ML model. The embodiments of FIG. 7 include, at block 750, updating the competence score of the ML model based on applying the first test.

In some examples, determining the performance measure for the first test can include determining the performance measure based on a difficulty parameter and a discrimination parameter for the first test and the competence score. In such examples, updating the competence score can include determining, based on the competence score and the difficulty parameter and discrimination parameter for the first test, a probability of success for the ML model with respect to the first test. This could include using a maximum likelihood estimator or a Bayesian estimator to update the competence score.

In some examples, determining the performance measure for the first test can include determining a probability of success for the ML model with respect to the first test and determining the performance measure for the first test based on a discrimination parameter for the first test and the probability of success. For example, the performance measure for the first test could be the Fisher Information of the first test with respect to evaluating the ML model.

By selecting the ‘most informative’ or otherwise improved test with respect to performance measure and then applying that selected first test, the ML model can be fully assessed via the application of fewer tests (e.g., than an exhaustive application of all tests, or a sequential application of the tests until failure/success). Accordingly, this results in a corresponding reduction in the processor cycles, memory, power, or other computational costs incurred in evaluating the ML model relative to alternative methods.

The embodiments of FIG. 7 include, at block 760, determining, based on the updated competence score and the one or more respective parameters for each of the tests, corresponding updated performance measures for each of the tests with respect to the ML model. The embodiments of FIG. 7 include, at block 770, selecting, based on the corresponding updated performance measures, a second test of the set of tests and, at block 780, applying the second test to evaluate the ML model. The embodiments of FIG. 7 include, at block 790, further updating the competence score of the ML model based on applying the second test.

As noted above, by iteratively selecting the ‘most informative’ or otherwise improved test with respect to a performance measure that is repeatedly updated based on the results of each applied test, and then applying the selected sequence of subsequent test(s), the ML model can be fully assessed via the application of fewer tests. This results in a corresponding reduction in the processor cycles, memory, power, or other computational costs incurred in evaluating the ML model relative to alternative methods. Additionally, such an iterative method allows the cost of assessment to be limited or otherwise throttled, e.g., by setting termination criteria relative to an estimated noise or uncertainty in the model competence score, so that less computation resources (e.g., processor cycles, power) can be expended to arrive at a less certain estimate, or vice versa.

The embodiments of FIG. 7 could additionally include, based on the updated competence score, determining that a termination criterion has not been satisfied. In such examples, selecting the second test, applying the second test to evaluate the ML model, and further updating the competence score of the ML model could be performed responsive to determining that the termination criterion has not been satisfied. Determining that the termination criterion has not been satisfied could include determining an error measurement for the updated competence score and determining that the error measurement is not less than a specified threshold value.

The embodiments of FIG. 7 could additionally include obtaining, for a set of ML models that includes the first ML model, a set of respective competence scores, wherein obtaining the competence score for the first ML model comprises updating the competence score of the first ML model based on applying the first test; and, based on the set of respective competence scores, selecting the first ML model and responsively using the first ML model to perform a target task. In such examples, selecting the first ML model could include identifying a subset of the set of ML models that satisfies a computational budget criterion, wherein the first ML model is a member of the subset; and, based on a set of respective competence scores for ML models of the subset, selecting the first ML model from the subset.

The embodiments of FIG. 7 could additionally include obtaining, for a set of ML models that includes the first ML model and that are stored in a database, a set of respective competence scores, wherein obtaining the competence score for the first ML model comprises updating the competence score of the first ML model based on applying the first test; and, based on the set of respective competence scores, selecting the first ML model and responsively deleting the first ML model from the database.

The embodiments of FIG. 7 could additionally include obtaining, for a set of ML models that includes the first ML model, a set of respective competence scores, wherein obtaining the competence score for the first ML model comprises updating the competence score of the first ML model based on applying the first test; and, based on the set of competence scores, updating the one or more respective parameters of each of the tests. In some examples, each test of the set of tests is stored in a database, and the embodiments of FIG. 7 further include, based on the updated one or more respective parameters of each of the tests, selecting a test of the set of tests and deleting the selected test from the database. Such an example could further include: (i) based on the updated one or more respective parameters of each of the tests, selecting a test of the set of tests and updating the set of tests by removing the selected test from the set of tests; (ii) updating the set of ML models by adding at least one ML model thereto; (iii) using the updated set of tests to determine, for the updated set of ML models, an updated set of respective competence scores; (iv) based on the updated set of respective competence scores, further updating the one or more respective parameters for each of the tests in the updated set of tests; and (v) based on the further updated one or more respective parameters, further updating the set of tests by adding thereto the selected test.

The embodiments of FIG. 7 could include additional or alternative steps and/or alternative version of the steps described above.

### X. CLOSING

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
obtaining a machine learning (ML) model and a competence score of the ML model;
obtaining a set of tests for evaluating ML models, wherein each test of the set of tests comprises one or more respective parameters, wherein the one or more respective parameters for a given test of the set of tests indicate performance of the given test in evaluating ML models;
determining, based on the competence score and the one or more respective parameters for each of the tests, corresponding performance measures for each of the tests with respect to the ML model;
based on the corresponding performance measures, selecting a first test of the set of tests;
applying the first test to evaluate the ML model;
based on applying the first test, updating the competence score of the ML model;
determining, based on the updated competence score and the one or more respective parameters for each of the tests, corresponding updated performance measures for each of the tests with respect to the ML model;
selecting, based on the corresponding updated performance measures, a second test of the set of tests;
applying the second test to evaluate the ML model; and
based on applying the second test, further updating the competence score of the ML model.

2. The method of claim 1, wherein the one or more respective parameters of each of the tests comprise a respective difficulty parameter for each of the tests and a respective discrimination parameter for each of the tests, and wherein determining the performance measure for the first test comprises determining the performance measure based on the difficulty parameter and discrimination parameter for the first test and the competence score.

3. The method of claim 2, wherein updating the competence score comprises determining, based on the competence score and the difficulty parameter and discrimination parameter for the first test, a probability of success for the ML model with respect to the first test.

4. The method of claim 3, wherein updating the competence score further comprises, based on the determined probability of success and a determination of whether the ML model succeeded at the first test, using a maximum likelihood estimator or a Bayesian estimator to update the competence score.

5. The method of claim 1, wherein the one or more respective parameters of each of the tests comprise a respective discrimination parameter for each of the tests, and wherein determining a performance measure for the first test comprises:
determining a probability of success for the ML model with respect to the first test; and
determining the performance measure for the first test based on the discrimination parameter for the first test and the probability of success.

6. The method of claim 5, wherein the performance measure for the first test is a Fisher Information of the first test with respect to evaluating the ML model.

7. The method of claim 1, further comprising:
based on the updated competence score, determining that a termination criterion has not been satisfied, wherein selecting the second test, applying the second test to evaluate the ML model, and further updating the competence score of the ML model are performed responsive to determining that the termination criterion has not been satisfied.

8. The method of claim 7, further comprising: determining an error measurement for the updated competence score, wherein determining that the termination criterion has not been satisfied comprises determining that the error measurement is not less than a specified threshold value.

9. The method of claim 1, wherein the ML model is a first ML model of a set of ML models, and wherein the method further comprises:
obtaining, for the set of ML models, a set of respective competence scores, wherein obtaining the competence score for the first ML model comprises updating the competence score of the first ML model based on applying the first test; and
based on the set of respective competence scores, selecting the first ML model and responsively using the first ML model to perform a target task.

10. The method of claim 9, wherein selecting the first ML model comprises:
identifying a subset of the set of ML models that satisfies a computational budget criterion, wherein the first ML model is a member of the subset; and
based on a set of respective competence scores for ML models of the subset, selecting the first ML model from the subset.

11. The method of claim 1, wherein the ML model is a first ML model of a set of ML models, wherein each ML model of the set of ML models is stored in a database, and wherein the method further comprises:
obtaining, for the set of ML models, a set of respective competence scores, wherein obtaining the competence score for the first ML model comprises updating the competence score of the first ML model based on applying the first test; and
based on the set of respective competence scores, selecting the first ML model and responsively deleting the first ML model from the database.

12. The method of claim 1, wherein the ML model is a first ML model of a set of ML models, and wherein the method further comprises:
obtaining, for the set of ML models, a set of respective competence scores, wherein obtaining the competence score for the first ML model comprises updating the competence score of the first ML model based on applying the first test; and
based on the set of competence scores, updating the one or more respective parameters of each of the tests.

13. The method of claim 12, wherein each test of the set of tests is stored in a database, and wherein the method further comprises:
based on the updated one or more respective parameters of each of the tests, selecting a test of the set of tests and deleting the selected test from the database.

14. The method of claim 13, wherein the method further comprises:
based on the updated one or more respective parameters of each of the tests, selecting a test of the set of tests and updating the set of tests by removing the selected test from the set of tests;
updating the set of ML models by adding at least one ML model thereto;
using the updated set of tests to determine, for the updated set of ML models, an updated set of respective competence scores;
based on the updated set of respective competence scores, further updating the one or more respective parameters for each of the tests in the updated set of tests; and
based on the further updated one or more respective parameters, further updating the set of tests by adding thereto the selected test.

15. A system comprising:
one or more processors; and
memory, containing program instructions that, upon execution by the one or more processors, cause the system to perform operations comprising:
obtaining a machine learning (ML) model and a competence score of the ML model;
obtaining a set of tests for evaluating ML models, wherein each test of the set of tests comprises one or more respective parameters, wherein the one or more respective parameters for a given test of the set of tests indicate performance of the given test in evaluating ML models;
determining, based on the competence score and the one or more respective parameters for each of the tests, corresponding performance measures for each of the tests with respect to the ML model;
based on the corresponding performance measures, selecting a first test of the set of tests;
applying the first test to evaluate the ML model;
based on applying the first test, updating the competence score of the ML model;
determining, based on the updated competence score and the one or more respective parameters for each of the tests, corresponding updated performance measures for each of the tests with respect to the ML model;
selecting, based on the corresponding updated performance measures, a second test of the set of tests;
applying the second test to evaluate the ML model; and
based on applying the second test, further updating the competence score of the ML model.

16. The system of claim 15, wherein the operations further comprise:
based on the updated competence score, determining that a termination criterion has not been satisfied, wherein selecting the second test, applying the second test to evaluate the ML model, and further updating the competence score of the ML model are performed responsive to determining that the termination criterion has not been satisfied.

17. The system of claim 15, wherein the ML model is a first ML model of a set of ML models, and wherein the operations further comprise:
obtaining, for the set of ML models, a set of respective competence scores, wherein obtaining the competence score for the first ML model comprises updating the competence score of the ML model based on applying the first test; and
based on the set of respective competence scores, selecting the first ML model and responsively using the first ML model to perform a target task.

18. A non-transitory computer-readable medium, having stored thereon program instructions that, upon execution by a computing system, cause the computing system to perform operations comprising:
obtaining a machine learning (ML) model and a competence score of the ML model;
obtaining a set of tests for evaluating ML models, wherein each test of the set of tests comprises one or more respective parameters, wherein the one or more respective parameters for a given test of the set of tests indicate performance of the given test in evaluating ML models;
determining, based on the competence score and the one or more respective parameters for each of the tests, corresponding performance measures for each of the tests with respect to the ML model;
based on the corresponding performance measures, selecting a first test of the set of tests;
applying the first test to evaluate the ML model;
based on applying the first test, updating the competence score of the ML model;
determining, based on the updated competence score and the one or more respective parameters for each of the tests, corresponding updated performance measures for each of the tests with respect to the ML model;
selecting, based on the corresponding updated performance measures, a second test of the set of tests;
applying the second test to evaluate the ML model; and
based on applying the second test, further updating the competence score of the ML model.

19. The computer-readable medium of claim 18, wherein the operations further comprise:
based on the updated competence score, determining that a termination criterion has not been satisfied, wherein selecting the second test, applying the second test to evaluate the ML model, and further updating the competence score of the ML model are performed responsive to determining that the termination criterion has not been satisfied.

20. The computer-readable medium of claim 18, wherein the ML model is a first ML model of a set of ML models, and wherein the operations further comprise:
obtaining, for the set of ML models, a set of respective competence scores, wherein obtaining the competence score for the first ML model comprises updating the competence score of the ML model based on applying the first test; and
based on the set of respective competence scores, selecting the first ML model and responsively using the first ML model to perform a target task.
